(19) United States
(12) Patent Application Publication
(10) Pub. No.: US 2020/0404115 A1
(43) Pub. Date: Dec. 24, 2020

(54) IMAGE FORMING APPARATUS

(71) Applicant: KYOCERA Document Solutions Inc., Osaka (JP)

(72) Inventor: Hitoshi ASAKA, Osaka-shi (JP)

(73) Assignee: KYOCERA Document Solutions Inc., Osaka (JP)

(21) Appl. No.: 16/905,818

(22) Filed: Jun. 18, 2020

(30) Foreign Application Priority Data
Jun. 24, 2019 (JP) 2019-116455

(51) Int. Cl. H04N 1/00

(52) U.S. Cl. CPC H04N 1/00639; H04N 1/00466

(57) ABSTRACT

An image forming apparatus includes an image forming section, a post-processor, storage, a first tray, a sensor, a display section, and a controller. The image forming section forms an image on paper. The post-processor staples or non-staples the paper, on which the image has been formed, to be ejected. The storage stores therein an operation history indicating that the post-processor has stapled the paper. The first tray holds the paper ejected from the post-processor. The sensor detects whether or not the paper ejected from the post-processor remains on the first tray. The display section displays a massage to a user. If it is determined from the operation history stored in the storage and a result of detection by the sensor that the stapled paper remains on the first tray, the controller controls the display section so that the display section displays a message saying that the stapled paper remains on the first tray.

### INCORPORATION BY REFERENCE

The present application claims priority under 36 U.S.C. § 119 to Japanese Patent Application No. 2019-116455, filed on Jun. 24, 2019. The contents of this application are incorporated herein by reference in their entirety.

### BACKGROUND

The present disclosure relates to an image forming apparatus.

An image forming apparatus includes an image forming section that forms an image on paper, a post-processor that staples or non-staples the image formed paper by the image forming section, to be ejected, and a tray that holds the paper ejected from the post-processor.

### SUMMARY

An image forming apparatus according to an aspect of the present disclosure includes an image forming section, a post-processor, storage, a first tray, a sensor, a display section, and a controller. The image forming section forms an image on paper. The post-processor staples or non-staples the paper, on which the image has been formed, to be ejected as stapled paper or non-stapled paper, respectively. The storage stores therein an operation history indicating that the post-processor has stapled the paper. The first tray holds the paper ejected from the post-processor. The sensor detects whether or not the paper ejected from the post-processor remains on the first tray. The display section displays a message to a user. If it is determined from the operation history stored in the storage and a result of detection by the sensor that the stapled paper remains on the first tray, the controller controls the display section so that the display section displays a message saying that the stapled paper remains on the first tray.

### BRIEF DESCRIPTION OF THE DRAWINGS

FIG. 1 is a perspective view of an image forming apparatus according to an embodiment of the present disclosure.

FIG. 2 is a sectional view of the image forming apparatus.

FIG. 3 is a block diagram of a controller of the image forming apparatus.

FIG. 4A depicts a first example of a message to be displayed on a display device.

FIG. 4B depicts a first example of settings to be entered through a touch panel.

FIG. 5 is a flowchart depicting a first example of an operation of the controller.

FIG. 6A depicts a second example of the message to be displayed on the display device.

FIG. 6B depicts a second example of the settings to be entered through the touch panel.

FIG. 7 is a flowchart depicting a second example of the operation of the controller.

FIG. 8A depicts a third example of the settings to be entered through the touch panel.

FIG. 8B depicts a third example of the message to be displayed on the display device.

FIG. 9 is a flowchart depicting a third example of the operation of the controller.

FIG. 10A depicts a fourth example of the settings to be entered through the touch panel.

FIG. 10B depicts a fourth example of the message to be displayed on the display device.

FIG. 11 is a flowchart depicting a fourth example of the operation of the controller.

FIG. 12A depicts a fifth example of the settings to be entered through the touch panel.

FIG. 12B depicts a fifth example of the message to be displayed on the display device.

FIG. 13 is a flowchart depicting a fifth example of the operation of the controller.

### DETAILED DESCRIPTION

An embodiment according to the present disclosure will be described with reference to the accompanying drawings. Elements of configuration which are the same or equivalent are labeled with the same reference signs in the drawings, and description thereof is not repeated.

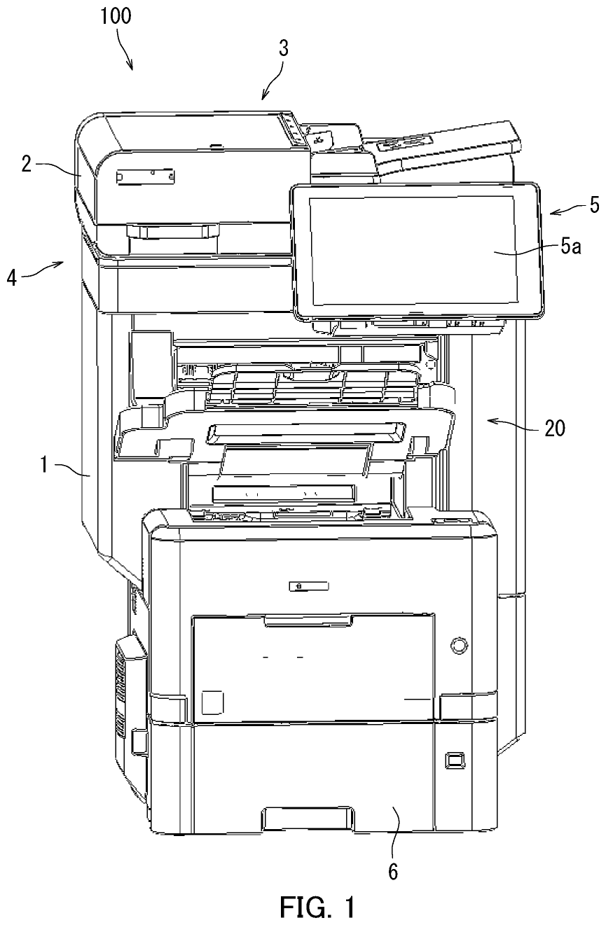

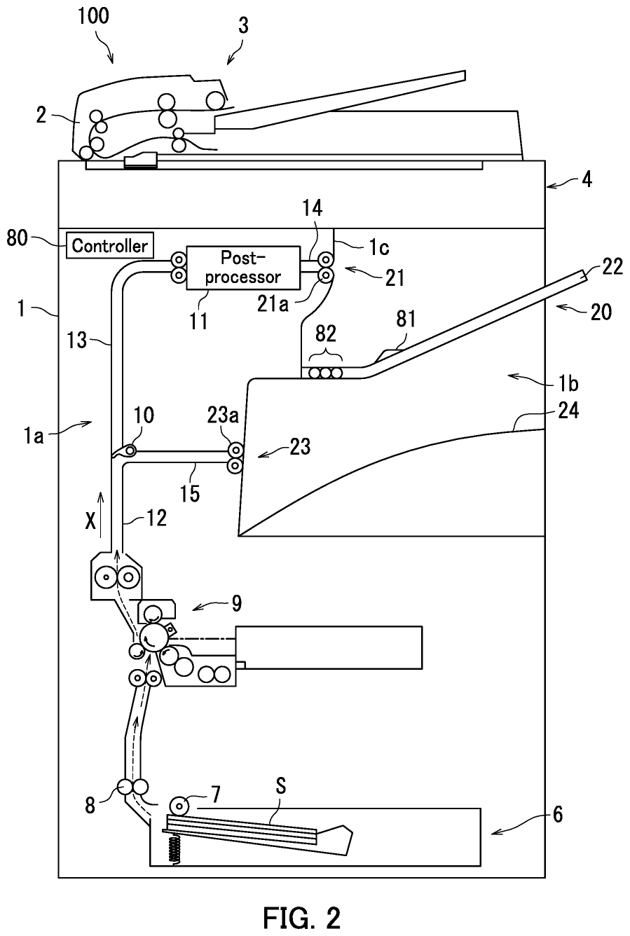

An image forming apparatus 100 according to the embodiment of the present disclosure will be described with reference to FIGS. 1 and 2. FIG. 1 is a perspective view of the image forming apparatus 100. FIG. 2 is a sectional view of the image forming apparatus 100.

As illustrated in FIG. 1, the image forming apparatus 100 includes a housing a cover 2, a first conveyance roller 3, a reading section 4, a display device 5, and a cassette 6. As illustrated in FIG. 2, the image forming apparatus 100 further includes a feeding roller 7, a second conveyance roller 8, an image forming section 9, a diverging guide 10, a post-processor 11, a first guide section 12, a second guide section 13, a third guide section 14, a fourth guide section 15, and an ejection section 20.

The housing 1 has a hollow shape. The housing 1 includes a wall 1c that separates an internal part 1a of the housing 1 and an external part 1b of the housing 1. The reading section 4, the cassette 6, the feeding roller 7, the second conveyance roller 8, the image forming section 9, the first guide section 12, the second guide section 13, the diverging guide 10, and the post-processor 11 are placed in the internal part 1a of the housing 1.

The cover 2 is attached to the housing 1 in a pivotable manner. The cover 2 has a hollow shape. The first conveyance roller 3 is placed inside the cover 2.

The first conveyance roller 3 conveys a document toward the reading section 4. When the document reaches the reading section 4, the reading section 4 scans a document image to capture image data representing the image. The reading section 4 includes for example a light emitting section such as light emitting diodes (LEDs) and an imaging section such as an image sensor. The reading section 4 reads the document image using the light emitting section and the imaging section. Reading glass (not illustrated) is set on part, facing the cover 2, of the housing 1. The reading section 4 scans the document image to capture the image data representing the image with the document placed between the reading glass and the cover 2.

The display device 5 includes a touch panel 5a. The touch panel 5a allows an instruction to be entered into the image forming apparatus 100. The display device 5 displays various pieces of information. Examples of the display device 5 include a liquid crystal display (LCD) and an organic electro luminescent display (ELD). The display device 5 corresponds to one example of a “display section”.

The cassette 6 houses paper S. The feeding roller 7 sends out the paper Sin the cassette 6 one sheet at a time. The second conveyance roller 8 sends out the paper S conveyed from the feeding roller 7 toward the image forming section 9.

The image forming section 9 forms an image on the paper S to obtain image formed paper S. The image is specifically a toner image. The image forming section 9 includes a photosensitive drum, a charger, a light exposure section, a developing section, a transfer section, a cleaner, and a static eliminator. An image is formed on the paper S by the photosensitive drum, the charger, the light exposure section, the developing section, and the transfer section. The cleaner removes toner remaining on a surface of the photosensitive drum. The static eliminator removes residual charge remaining on the surface of the photosensitive drum. After the image is formed on the paper S, the image forming section 9 sends out the paper S toward a fixing section. The fixing section applies heat and pressure to the image to fix the image to the paper S.

The diverging guide 10 is placed downstream of the image forming section 9 in a conveyance direction X of the paper S. The conveyance direction X of the paper S corresponds to a movement direction of the paper S when the image forming section 9 forms an image on the paper S. The diverging guide 10 corresponds to one example of a “diverging section”.

The post-processor 11 is placed downstream of the diverging guide 10 in the conveyance direction X of the paper S. The post-processor 11 performs predetermined post-processing of the paper S. Examples of the predetermined post-processing include punching, stapling, center folding, and aligning. The punching means making (a) punch holes in paper S. The stapling means fastening sheets of paper together with a binding member(s) such as a staple(s). The center folding means folding the paper S in half. The aligning means performing paper shift or paper width alignment. Regarding the stapling, the post-processor 11 includes a function of stapling or non-stapling the image formed paper S to be ejected as stapled paper S or non-stapled paper S, respectively.

Each of the first guide section 12, the second guide section 13, the third guide section 14, and the fourth guide section 15 includes for example a guideway and a pair of rollers. The guideway is formed in the conveyance direction X. The pair of rollers rotates while nipping the paper S to convey the paper S along the guideway.

The first guide section 12 is interposed between the image forming section 9 and the diverging guide 10. The first guide section 12 guides, to the diverging guide 10, the paper S that has passed through the image forming section 9.

The second guide section 13 is interposed between the diverging guide 10 and the post-processor 11. The second guide: section 13 guides the paper S from the diverging guide 10 to the post-processor 11.

The third guide section 14 is interposed between the post-processor 11 and the ejection section 20. The third guide section 14 guides the paper S from the post-processor 11 to the ejection section 20.

The fourth guide section 15 is interposed between the diverging guide 10 and the ejection section 20. The fourth guide section 15 guides the paper S from the diverging guide 10 to the ejection section 20.

The diverging guide 10 is supported in a pivotable manner. An orientation of the diverging guide 10 is switchable between a first guide orientation and a second guide orientation. The first guide orientation is an orientation of the diverging guide 10 by which the first guide section 12 is communicated with the second guide section 13 with communication between the first guide section 12 and the fourth guide section 15 disconnected. The second guide orientation is an orientation of the diverging guide 10 by which the first guide section 12 is communicated with the fourth guide section 15 with communication between the first guide section 12 and the second guide section 13 disconnected.

When the orientation of the diverging guide 10 is the first guide orientation, the diverging guide 10 guides the paper S from the first guide section 12 to the second guide section 13. The second guide section 13 guides the paper S to the post-processor 11. The post-processor 11 performs the predetermined post-processing of the paper S. The third guide section 14 guides, to the ejection section 20, the paper S that has passed through the post-processor 11. The ejection section 20 ejects the paper S to the external part 1b of the housing 1.

When the orientation of the diverging guide 10 is the second guide orientation, the diverging guide 10 guides the paper S from the first guide section 12 toward the fourth guide section 15. The fourth guide section 15 guides the paper S toward the ejection section 20. The ejection section 20 ejects the paper S toward the external part 1b of the housing 1.

As illustrated in FIG. 2, the ejection section 20 includes a first ejection section 21, a document finisher (DF) tray 22, a second ejection section 23, and a main body tray 24. The DF tray 22 corresponds to an example of a “first tray”. The main body tray 24 corresponds to an example of a “second tray”.

The first ejection section 21 includes a first roller pair 21a. The first roller pair 21a rotates while nipping the paper S and ejects, toward the DF tray 22, the paper S that has been ejected from the post-processor 11.

The DF tray 22 holds the paper S that has been ejected by the first ejection section 21. The IV tray 22 is in the shape of a plate body attached to the housing 1 inside the body of the housing 1. The DF tray 22 includes a sensor 81 and LEDs 82. The sensor 81 detects whether or not the paper S ejected from the post-processor 11 remains on the DF tray 22. The LEDs 82 are located on a side surface of the DF tray 22. When the stapled paper S remains on the DF tray 22, the LEDs 82 indicate a staple location of the stapled paper S. The LEDs 82 are controlled so as to indicate a message saying that the stapled paper S remains on the DF tray 22. The LEDs 82 correspond to an example of an “indicator” and an example of a “display section”.

The second ejection section 23 includes a second roller pair 23a. The second roller pair 23a rotates while nipping the paper S to eject, toward the main body tray 24, the paper S incoming without passing through the post-processor 11.

The main body tray 24 holds the non-stapled paper S that is the image formed paper S obtained from the image forming section 9 and that is non-stapled. The main body tray 24 is attached to an external surface of the housing 1 in a recess of the body of the housing 1.

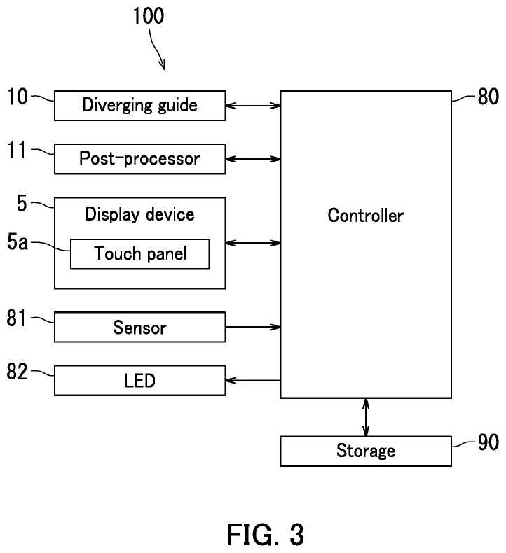

Next, the image forming apparatus 100 will further be described with reference to FIGS. 1 to 3. FIG. 3 is a block diagram of a controller 80 of the image forming apparatus 100.

As illustrated in FIG. 3, the image forming apparatus 100 further includes storage 90 connected to the controller 80.

The storage 90 includes a storage device. The storage device includes a main memory device that is for example semiconductor memory such as read-only memory (ROM) and random-access memory (RAM). The storage device may further include an auxiliary storage device that is for example a hard disk drive. The main memory and/or the auxiliary storage device store various data and various computer programs to be executed by the controller 80. The various data include various messages, various settings, and a first operation history and a second operation history of the post-processor 11.

The controller 80 includes a processor such as a central processing unit (CPU) and a micro processing unit (MPU). The processor of the controller 80 executes the computer programs stored in the storage device, thereby controlling each element of the image forming apparatus 100. Specifically, the processor of the controller 80 receives a result of detection by the sensor 81. The processor of the controller 80 also controls the display device 5, the diverging guide 10, the post-processor 11, the storage 9, and the LEDs 82. When the post-processor 11 has actually ejected the stapled paper 5, the controller 80 sets the first operation history in the storage 90. When the post-processor 11 has actually ejected the non-stapled paper S, the controller 80 sets the second operation history in the storage 90. When all sheets of paper S on the DF tray 22 have been removed, the controller 80 resets the first and second operation histories in the storage 90.

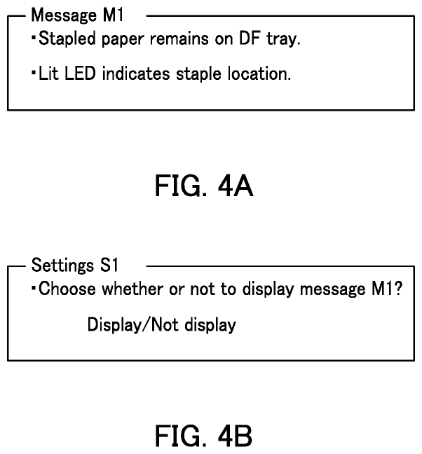

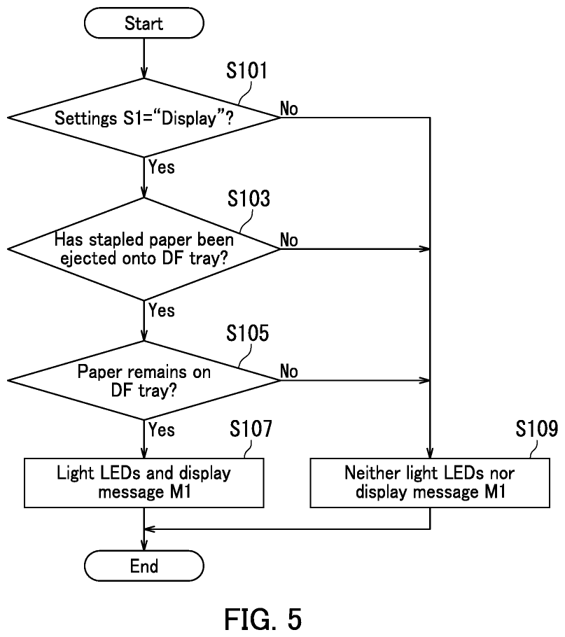

A first example of an operation of the controller 80 will next be described with reference to FIGS. 1 to 5. FIG. 4A illustrates a first example of a message (message M1) displayed on the display device 5. FIG. 4B illustrates a first example of settings (settings S1) to be entered through the touch panel 5a. FIG. 5 is a flowchart depicting the first example of the operation of the controller 80.

As illustrated in FIG. 4A, the message M1 includes a text of “Stapled paper remains on DF tray.” and a text of “Lit LED indicates staple location.” The message M1 is stored in the storage 90 in advance.

As illustrated in FIG. 4B, the settings S1 include a question and an answer to the question. Here, the question is “Choose whether or not to display message M1?” The answer is “Display” or “Not display” that is to be obtained from a user. The controller 80 stores, in the storage 90, the settings S1 obtained through dialogue with the user through the display device 5.

At Step S101: the controller 80 determines whether or not the settings S1 read from the storage 90 include “Display” as illustrated in FIG. 5. When the controller 80 determines that the settings S1 include “Display” (Yes at Step S101), a process of the controller 80 proceeds to Step S103, When the controller 80 determines that the settings S1 do not include “Display” (No at Step S101), the process of the controller 80 proceeds to Step S109.

At Step S103: the controller 80 determines whether or not the stapled paper S has been ejected on the DF tray 22 based on a first operation history stored in the storage 90. When the controller 80 determines that the stapled paper S has been ejected on the DF tray 22 (Yes at Step S103), the process of the controller 80 proceeds to Step S105. When the controller 80 determines that the stapled paper S has not been ejected on the DF tray 22 (No at Step S103), the process of the controller 80 proceeds to Step S109.

At Step S105: the controller 80 receives a result of detection by the sensor 81 and then determines whether or not paper S remains on the DF tray 22. When the controller 80 determines that paper S remains on the DF tray 22 (Yes at Step S105), the process of the controller 80 proceeds to Step S107. When the controller 80 determines that no paper S remains on the DF tray 22 (No at Step S105), the process of the controller 80 proceeds to Step S109.

At Step S107: the controller 80 controls the LEDs 82 so that any of the LEDs 82 is lit. The controller 80 also controls the display device 5 so that the message M1 read from the storage 90 is displayed thereon. The process of the controller 80 ends when Step S107 in the process ends.

At Step S109: the controller 80 controls the LEDs 82 so that none of the LEDs 82 are lit. The controller 80 also controls the display device 5 so that the message M1 is not displayed thereon. The process of the controller 80 ends when Step S109 in the process ends.

Thus, in the first example, when it is determined from the result of detection by the sensor 81 that the stapled paper S remains on the DF tray 22, the controller 80 controls the display device 5 so that the message M1 is displayed thereon. The message M1 indicates that the stapled paper S remains on the DF tray 22. This enables the user to carefully take out the paper S from the DF tray 22 without doing damage to the paper S.

In addition, when the stapled paper S remains on the DF tray 22, the controller 80 controls the LEDs 82 so that any of the LEDs 82 is lit. This enables the user to take out the paper S from the DF tray 22 while checking the staple location of the paper S.

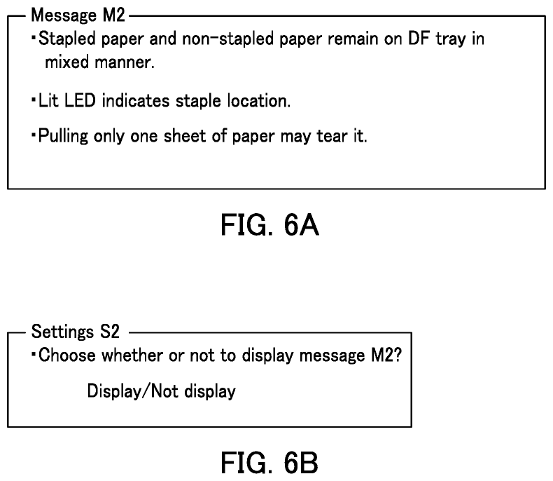

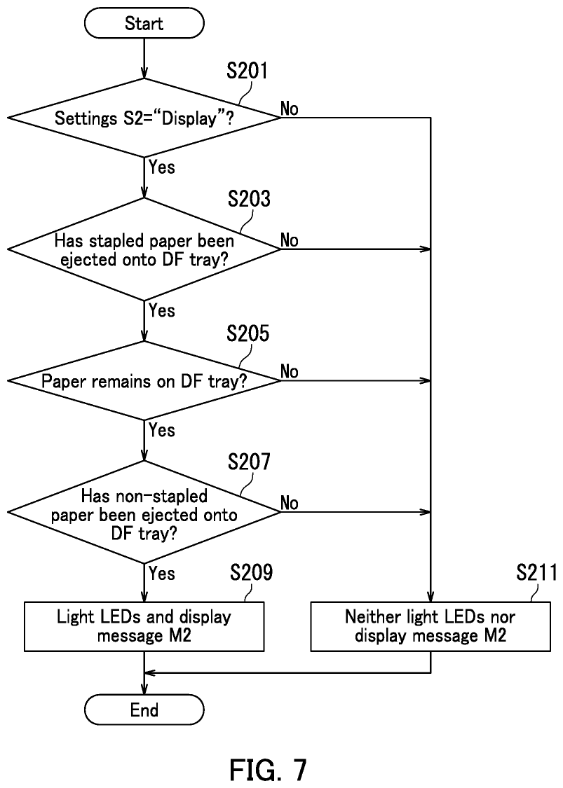

A second example of the operation of the controller 80 will next be described with reference to FIGS. 1 to 3, 6A, 6B, and 7. FIG. 6A depicts a second example of a message (message M2) to be displayed on the display device 5. FIG. 6B depicts a second example of settings (settings S2) to be entered through the touch panel 5a. FIG. 7 is a flowchart depicting the second example of the operation of the controller 80.

As illustrated in FIG. 6A, the message M2 includes a text of “Stapled paper and non-stapled paper remain on DF tray in mixed manner.”, a text of “Lit LED indicates staple location.”, and a text of “Pulling only one sheet of paper may tear it.” The message M2 is stored in the storage 90 in advance.

As illustrated in FIG. 6B, the settings S2 include a question and an answer to the question. Here, the question is “Choose whether or not to display message M2?” The answer is “Display” or “Not display” that is to be obtained from the user. The controller 80 stores, in the storage 90, the settings S2 obtained through dialogue with the user through the display device 5.

At Step S201: the controller 80 determines whether or not the settings S2 read from the storage 90 include “Display” as illustrated in FIG. 7. When the controller 80 determines that the settings S2 include “Display” (Yes at Step S201), a process of the controller 80 proceeds to Step S203. When the controller 80 determines that the settings S2 do not include “Display” (No at Step S201), the process of the controller 80 proceeds to Step S211.

At Step S203: the controller 80 determines whether or not the stapled paper S has been ejected on the DF tray 22 based on the first operation history stored in the storage 90. When the controller 80 determines that the stapled paper S has been ejected on the DF tray 22 (Yes at Step S203), the process of the controller 80 proceeds to Step S205. When the controller 80 determines that the stapled paper S has not been ejected on the DF tray 22 (No at Step S203), the process of the controller 80 proceeds to Step S211.

At Step S205: the controller 80 receives a result of detection by the sensor 81 and then determines whether or not the paper S remains on the DF tray 22. When the controller 80 determines that the paper S remains on the DF tray 22 (Yes at Step S205), the process of the controller 80 proceeds to Step S207. When the controller 80 determines that no paper S remains on the DF tray 22 (No at Step S205), the process of the controller 80 proceeds to Step S211.

At Step S207: the controller 80 determines whether or not the non-stapled paper S has been ejected on the DF tray 22 based on the second operation history stored in the storage 90. When the controller 80 determines that the non-stapled paper S has been ejected on the DF tray 22 (Yes at Step S207), the process of the controller 80 proceeds to Step S209. When the controller 80 determines that no non-stapled paper S has been ejected on the DF tray 22 (No at Step S207), the process of the controller 80 proceeds to Step S211.

At Step S209: the controller 80 controls the LEDs 82 so that any of the LEDs 82 is lit. In addition, the controller 80 controls the display device 5 so that the message M2 read from the storage 90 is displayed thereon. The process of the controller 80 ends when Step S209 in the process ends.

At Step S211: the controller 80 controls the LEDs 82 so that the LEDs 82 are unlit. In addition, the controller 80 controls the display device 5 so that the message M2 is not displayed thereon. The process of the controller 80 ends when Step S211 in the process ends.

Thus, in the second example, the controller 80 controls the display device 5 so that the display device 5 displays the message M2 indicating that the stapled paper S and the non-stapled paper S remains on the DF tray 22 in a mixed manner when the non-stapled paper S has been ejected on the DF tray 22 with the stapled paper S remaining on the DF tray 22. This enables the user to carefully take out desired paper S from the DF tray 22 without doing damage to the stapled paper S.

In addition, when the stapled paper S remains on the DF tray 22, the controller 80 controls the LEDs 82 so that any of the LEDs 82 is lit. This enables the user to take out the stapled paper S from the DF tray 22 while checking the staple location of the stapled paper S.

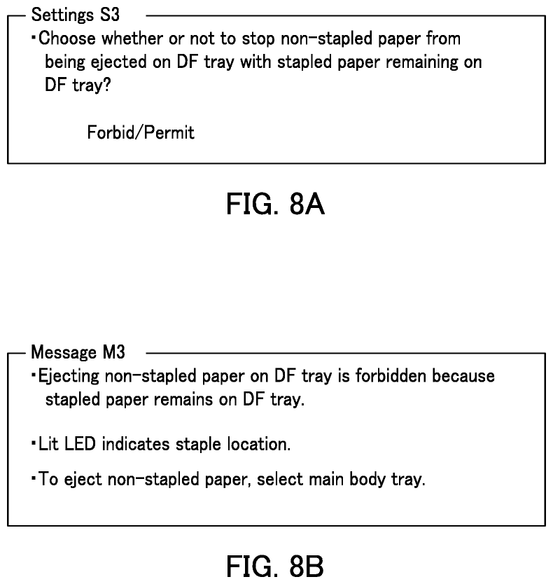

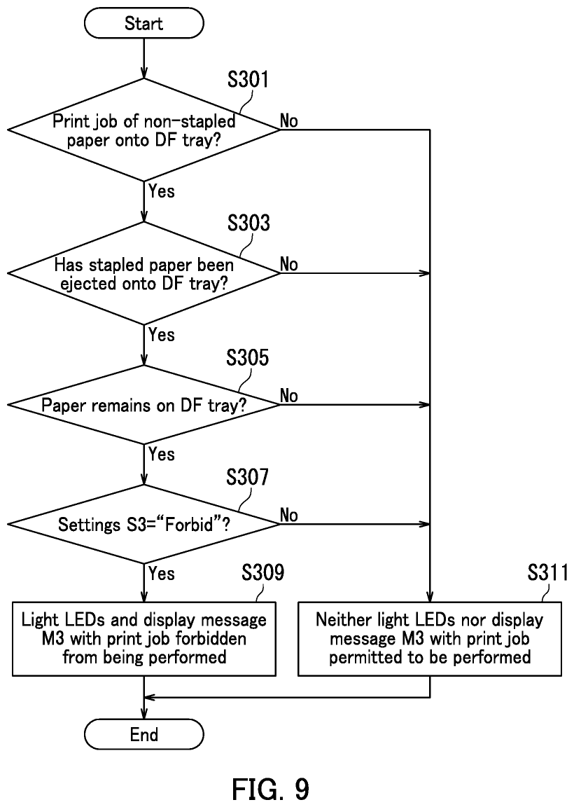

A third example of the operation of the controller 80 will next be described with reference to FIGS. 1 to 3, 8A, 8B, and 9. FIG. 8A depicts a third example of settings (settings S3) to be entered through the touch panel 5a. FIG. 8B depicts a third example of a message (message M3) to be displayed on the display device 5. FIG. 9 is a flowchart depicting the third example of the operation of the controller 80.

As illustrated in FIG. 8A, the settings S3 include a question and an answer to the question. Here, the question is “Choose whether or not to stop non-stapled paper from being ejected on DF tray with stapled paper remaining on DF tray?” The answer is “Forbid” or “Permit” that is to be obtained from the user. The controller 80 stores, in the storage 90, the settings S3 obtained through dialogue with the user through the display device 5.

As illustrated in FIG. 8B, the message M3 includes a text of “Ejecting non-stapled paper on DF tray is forbidden because stapled paper remains on DF tray”, a text of “Lit LED indicates staple location.”, and a text of “To eject non-stapled paper, select main body tray.” The message M3 is stored in the storage 90 in advance.

At Step S301: the controller 80 determines whether or not a current job is a print job of non-stapled paper onto the DF tray 22 as illustrated in FIG. 9. When the controller 80 determines that the current job is the print job of non-stapled paper onto the DF tray 22 (Yes at Step S301), the process of the controller 80 proceeds to Step S303, When the controller 80 determines that the current job is not the print job of non-stapled paper onto the DF tray 22 (No at Step S301), the process of the controller 80 proceeds to Step S311.

At Step S303: the controller 80 determines whether or not the stapled paper S has been ejected on the DF tray 22 based on the first operation history stored in the storage 90. When the controller 80 determines that the stapled paper S has been ejected on the DF tray 22 (Yes at Step S303), the process of the controller 80 proceeds to Step S305. When the controller 80 determines that no stapled paper S has been ejected on the DF tray 22 (No at Step S303), the process of the controller 80 proceeds to Step S311.

At Step S305: the controller 80 receives a result of detection by the sensor 81 and then determines whether or not the paper S remains on the DF tray 22. When the controller 80 determines that the paper S remains on the DF tray 22 (Yes at Step S305), the process of the controller 80 proceeds to Step S307. When the controller 80 determines that no paper S remains on the DF tray 22 (No at Step S305), the process of the controller 80 proceeds to Step S311.

At Step S307: the controller 80 determines whether or not the settings S3 read from the storage 90 include “Forbid”. When the controller 80 determines that the settings S3 include “Forbid” (Yes at Step S307), the process of the controller 80 proceeds to Step S309, When the controller 80 determines that the settings S3 do not include “Forbid” (No at Step S307), the process of the controller 80 proceeds to Step S311.

At Step S309: the controller 80 controls the LEDs 82 so that any of the LEDs 82 is lit. In addition, the controller 80 controls the post-processor 11 so as to forbid the current print job from being performed. Moreover, the controller 80 controls the display device 5 so that the message M3 read from the storage 90 is displayed thereon. The process of the controller 80 ends when Step S309 in the process ends.

At Step S311, the controller 80 controls the LEDs 82 so that the LEDs 82 are unlit. In addition, the controller 80 controls the post-processor 11 so as to permit the current print job to be performed. Moreover, the controller 80 controls the display device 5 so that the message M3 is not displayed thereon. The process of the controller 80 ends when Step S311 in the process ends.

Thus, in the third example, the controller 80 controls the post-processor 11 so as to forbid the non-stapled paper S from further being ejected on the DF tray 22 with the stapled paper S remaining on the DF tray 22. As a result, the stapled paper S and the non-stapled paper S are prevented from remaining on the DF tray 22 in a mixed manner.

When the non-stapled paper S remains on the DF tray 22, the controller 80 controls the LEDs 82 so that any of the LEDs 82 is lit. This enables the user to take out the stapled paper S from the DF tray 22 while checking the staple location of the stapled paper S.

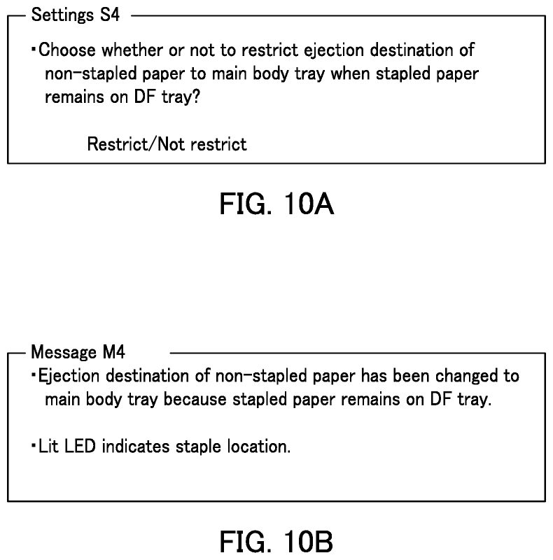

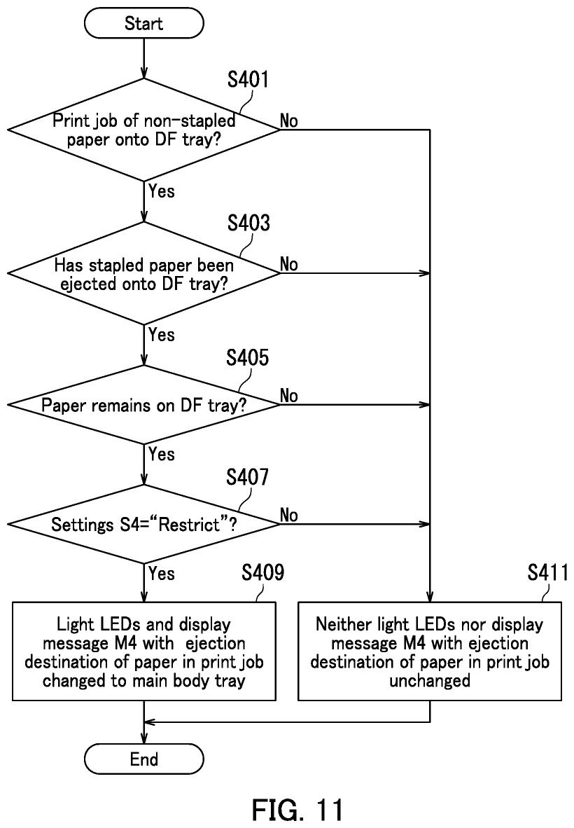

A fourth example of the operation of the controller 80 will next be described with reference to FIGS. 1 to 3, 10A, 10B, and 11. FIG. 10A depicts a fourth example of settings (settings S4) to be entered through the touch panel 5a. FIG. 10B depicts a fourth example of a message (message M4) to be displayed on the display device 5. FIG. 11 is a flowchart depicting the fourth example of the operation of the controller 80.

As illustrated in FIG. 10A, the settings S4 include a question and an answer to the question. Here, the question is “Choose whether or not to restrict ejection destination of non-stapled paper to main body tray with stapled paper remaining on DF tray?” The answer is “Restrict” or “Not restrict” that is to be obtained from the user. The controller 80 stores, in the storage 90, the settings S4 obtained through dialogue with the user through the display device 5.

As illustrated in FIG. 10B, the message M4 includes a text of “Ejection destination of non-stapled paper has been changed to main body tray because stapled paper remains on DF tray.” and a text of “Lit LED indicates staple location.” The message M4 is stored in the storage 90 in advance.

At Step S401: the controller 80 determines whether or not a current job is the print job of non-stapled paper onto the DF tray 22 as illustrated in FIG. 11. When the controller 80 determines that the current job is the print job of non-stapled paper onto the DF tray 22 (Yes at Step S401), a process of the controller 80 proceeds to Step S403. When the controller 80 determines that the current job is not the print job of non-stapled paper onto the DF tray 22 (No at Step S401), the process of the controller 80 proceeds to Step S411.

At Step S403: the controller 80 determines whether or not the stapled paper S has been ejected on the DF tray 22 based on the first operation history stored in the storage 90. When the controller 80 determines that the stapled paper S has been ejected on the DF tray 22 (Yes at Step S403), the process of the controller 80 proceeds to Step S405. When the controller 80 determines that no stapled paper S has been ejected on the DF tray 22 (No at Step S403), the process of the controller 80 proceeds to Step S411.

At Step S405: the controller 80 receives a result of detection by the sensor 84 and then determines whether or not the paper S remains on the DF tray 22. When the controller 80 determines that the paper S remains on the DF tray 22 (Yes at Step S405), the process of the controller 80 proceeds to Step S407. When the controller 80 determines that no paper S remains on the DF tray 22 (No at Step S405), the process of the controller 80 proceeds to Step S411.

At Step S407: the controller 80 determines whether or not the settings S4 read from the storage 90 include “Restrict”. When the controller 80 determines that the settings S4 include “Restrict” (Yes at Step S407), the process of the controller 80 proceeds to Step S409. When the controller 80 determines that the settings S4 do not include “Restrict” (No at Step S407), the process of the controller 80 proceeds to Step S411.

At Step S409: the controller 80 controls the LEDs 82 so that any of the LEDs 82 is lit. In addition, the controller 80 controls the diverging guide 10 so that the ejection destination of paper in the current print job is changed to the main body tray 24. Moreover, controller 80 controls the display device 5 so that the message M4 read from the storage 90 is displayed thereon. The process of the controller 80 ends when Step S409 in the process ends.

At Step S411: the controller 80 controls the LEDs 82 so that the LEDs 82 are unlit. In addition, the controller 80 controls the diverging guide 10 so that the ejection destination of paper in the current print job is not changed from the DF tray 22. Moreover, the controller 80 controls the display device 5 so that the message M4 is not displayed thereon. The process of the controller 80 ends when Step S411 of the process ends.

Thus, in the fourth example, the controller 80 controls the diverging guide 10 so that the ejection destination of the non-stapled paper S is restricted only to the main body tray 24 during the stapled paper S remaining on the DF tray 22. As a result, the stapled paper S and the non-stapled paper S are prevented from remaining on the DF tray 22 in a mixed manner.

When the stapled paper S remains on the DF tray 22, the controller 80 controls the LEDs 82 so that any of the LEDs 82 is lit. This enables the user to take out the stapled paper S from the DF tray 22 while checking the staple location of the stapled paper S.

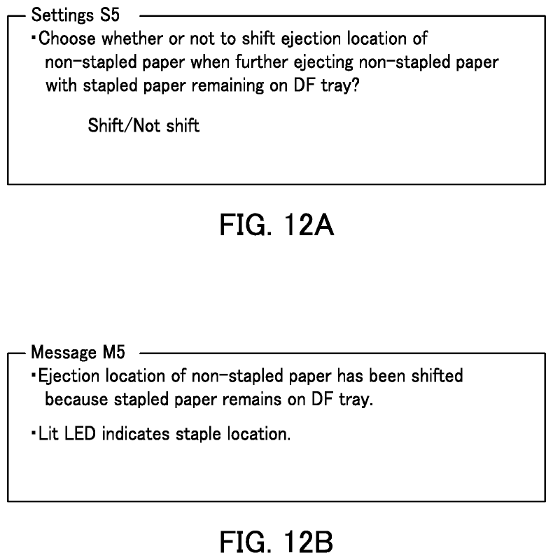

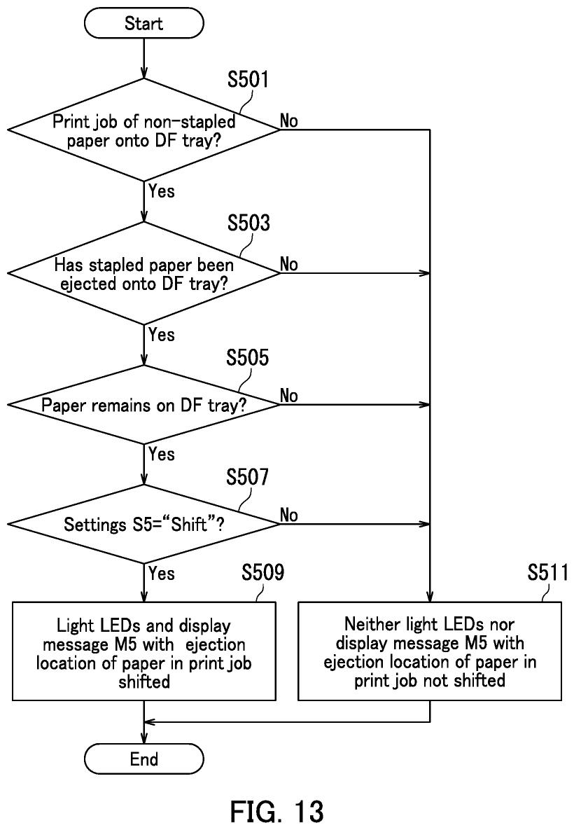

A fifth example of the operation of the controller 80 will next be described with reference to FIGS. 1 to 3, 12A, 12B, and 13. FIG. 12A depicts a fifth example of settings (settings S5) to be entered through the touch panel 5a. FIG. 12B depicts a fifth example of a message (message M5) to be displayed on the display device 5. FIG. 13 is a flowchart depicting the fifth example of the operation of the controller 80.

As illustrated in FIG. 12A, the settings S5 include a question and an answer to the question. Here, the question is “Choose whether or not to shift ejection location of non-stapled paper when further ejecting the non-stapled paper with stapled paper remaining on DF tray?” The answer is “Shift” or “Not shift” that is to be obtained from the user. The controller 80 stores, in the storage 90, the settings S5 obtained through dialogue with the user through the display device 5.

As illustrated in FIG. 12B, the message M5 includes a text of “Ejection location of non-stapled paper has been shifted because stapled paper remains on DF tray.” and a text of “Lit LED indicates staple location.” The message M5 is stored in the storage 90 in advance.

At Step S501: the controller 80 determines whether or not a current job is a print job of non-stapled paper onto the DF tray 22 as illustrated in FIG. 13. When the controller 80 determines that the current job is the print job of non-stapled paper onto the DF tray 22 (Yes at Step S501), a process of the controller 80 proceeds to Step S503. When the controller 80 determines that the current job is not the print job of non-stapled paper onto the DF tray 22 (No at Step S501), a process of the controller 80 proceeds to Step S511.

At Step S503: the controller 80 determines whether or not the stapled paper S has been ejected on the DF tray 22 based on the first operation history stored in the storage 90. When the controller 80 determines that the stapled paper S has been ejected on the DF tray 22 (Yes at Step S503), the process of the controller 80 proceeds to Step S505. When the controller 80 determines that no stapled paper S has been ejected on the DF tray 22 (No at Step S503), the process of the controller 80 proceeds to Step S511.

At Step S505: the controller 80 receives a result of detection by the sensor 81 and then determines whether or not the paper S remains on the DF tray 22. When the controller 80 determines that the paper S remains on the DF tray 22 (Yes at Step S505), the process of the controller 80 proceeds to Step S507. When the controller 80 determines that no paper S remains on the DF tray (No at Step S505), the process of the controller 80 proceeds to Step S511.

At Step S507: the controller 80 determines whether or not the settings S5 read from the storage 90 include “Shift”. When the controller 80 determines that the settings S5 include “Shift” (Yes at Step S507), the process of the controller 80 proceeds to Step S509. When the controller 80 determines that the settings S5 do not include “Shift” (No at Step S507), the process of the controller 80 proceeds to Step S511.

At Step S509: the controller 80 controls the LEDs 82 so that any of the LEDs 82 is lit. In addition, the controller 80 controls the post-processor 11 so that the ejection location of the paper S in the current print job is shifted. Moreover, the controller 80 controls the display device 5 so that the message M5 read from the storage 90 is displayed thereon. The process of the controller 80 ends when Step S509 in the process ends.

At Step S511: the controller 80 controls the LEDs 82 so that the LEDs 82 are unlit. In addition, the controller 80 controls the post-processor 11 so that the ejection location of the paper S in the current print job is not shifted. Moreover, the controller 80 controls the display device 5 so that the message M5 is not displayed thereon. The process of the controller 80 ends when Step S511 in the process ends.

Thus, in the fifth example, the controller 80 controls the post-processor 11 when further ejecting the non-stapled paper on the DF tray 22 with the stapled paper S remaining on the DF tray 22. Specifically, the controller 80 controls the post-processor 11 so that the ejection location of the non-stapled paper S is shifted. This enables the user to carefully take out the stapled paper S from the DF tray 22 without doing damage to the stapled paper S.

When the stapled paper S remains on the DF tray 22, the controller 80 controls the LEDs 82 so that any of the LEDs 82 is lit. This enables the user to take out the stapled paper S from the DF tray 22 while checking the staple location of the stapled paper S.

Note that the above-described first to fifth examples can be combined as appropriate.

As above, an embodiment of the present disclosure has been described with reference to the drawings. However, the present disclosure is not limited to the above-described embodiment and can be practiced in various ways within the scope without departing from the essence of the present disclosure. Constituent elements disclosed in the above embodiment can be combined as appropriate in various different forms. For example, some constituent elements may be omitted from all of the constituent elements described in the embodiment. The drawings mainly illustrate schematic constituent elements in order to facilitate understanding of the disclosure, and numbers and the like of constituent elements illustrated in the drawings may differ from actual properties thereof in order to facilitate preparation of the drawings. Furthermore, each constituent element described in the above embodiment is merely an example and is not intended as specific limitations. Various alterations may be made so long as there is no substantial deviation from the effects of the present disclosure.

In the present embodiment, the image forming apparatus 100 forms a toner image on paper S. However, the present disclosure is not limited to this. The image forming apparatus 100 needs to have a function of forming an image on paper S. The image forming apparatus 100 may be for example an inkjet printer. The image forming apparatus 100 is not limited to a single printer. Example of the image forming apparatus 100 can include a copier, a facsimile machine, and a multifunction peripheral.

What is claimed is:

1. An image forming apparatus, comprising:
an image forming section configured to form an image on paper;
a post-processor configured to staple or non-staple the paper, on which the image has been formed, to be ejected as stapled paper or non-stapled paper, respectively;
storage that stores therein an operation history indicating that the post-processor has stapled the paper;
a first tray configured to hold the paper ejected from the post-processor;
a sensor configured to detect whether or not the paper ejected from the post-processor remains on the first tray;
a display section configured to display a massage to a user; and
a controller configured to control the display section so that, if it is determined from the operation history stored in the storage and a result of detection by the sensor that the stapled paper remains on the first tray, the display section displays a message saying that the stapled paper remains on the first tray.

2. The image forming apparatus according to claim 1, wherein
if the non-stapled paper has been ejected on the first tray with the stapled paper remaining on the first tray, the controller controls the display section so that the display section displays a message saying that the stapled paper and the non-stapled paper remain on the first tray in a mixed manner.

3. The image forming apparatus according to claim 1, wherein
the controller controls the post-processor so as to forbid the non-stapled paper from further being ejected on the first tray if the stapled paper remains on the first tray.

4. The image forming apparatus according to claim 1, further comprising
a second tray, and
a diverging section configured to cause the image forming apparatus to eject, to the second tray, the non-stapled paper that is the paper on which the image has been formed and that is not stapled, wherein
the controller controls the diverging section so that if the stapled paper remains on the first tray, an ejection destination of the non-stapled paper is restricted only to the second tray.

5. The image forming apparatus according to claim 1, wherein
if further ejecting the non-stapled paper on the first tray in a case where the stapled paper remains on the first tray, the controller controls the post-processor so that an ejection location of the non-stapled paper is shifted.

6. The image forming apparatus according to claim 1, wherein
the display section includes an indicator configured to indicate a staple location of the stapled paper,
the first tray is provided with the indicator, and
the controller controls the indicator so that the indicator is lit if the stapled paper remains on the first tray.
